(19) United States
(12) Patent Application Publication
(10) Pub. No.: US 2006/0218908 A1
(43) Pub. Date: Oct. 5, 2006

(54) Hydraulic compressor

(76) Inventor: Afif Abou-Raphael, Gatineau (CA)

Correspondence Address: AFIF ABOU-RAPHAEL, 250 MAISONNEUVE BLV., GATINEAU, QC, J8X 3N8, CA

(21) Appl. No.: 11/091,114

(22) Filed: Mar. 29, 2005

(51) Int. Cl. F16D 31/02

(52) U.S. Cl. 60/398

(57) ABSTRACT

The subject of this invention is a hydraulic compressor that uses the clean and renewable energy of any flow of any waterway having a difference in height between the water intake and the water discharge, in order to admit and compress air in the said hydraulic compressor without doing any damage to the environment. It uses water pressure to compress air in a pipe and the compressed air is collected in a pressure tank to be used later to run a power plant such as that described in CA patent no 2328580.

This invention relates to the construction of a hydraulic compressor that uses renewable energy.

The subject of this invention is a hydraulic-like compressor; that uses the clean and renewable energy of any flow of any waterway having a difference in height between two points along the waterway in order to utilize the potential energy of water to compress air in the said hydraulic compressor. It uses a pipe that replaces the cylinder, and water that replaces the piston of compressors, and it eliminates the use of non-renewable energy while ensuring ease of operation, efficiency and the conservation of energy.

The embodiment of this invention includes the following:

1—A water line that brings the water of a stream, a river, a dam, etc. from a high point to the hydraulic compressor, as long as a difference in height exists in the water-way that permits the water to flow by gravity. The water-line has an inlet and an outlet. The inlet is located at an upstream of the water supply, and the outlet is located at a downstream of the water supply.

2—A main valve connected to outlet of said water-line to control the flow of water supplied by the water-line into and out of water-line called the line-cylinder.

3—A line-cylinder having an inlet and an outlet connected to the main valve that controls the water admission in order to compress air, and the water discharge that occurs at the end of the exhaust of compressed air to allow atmospheric air to enter the line-cylinder. The exhaust of compressed air and the admission of atmospheric air are done through air inlet and outlet valves that are located at a higher point then that of the water inlet and outlet.

4—An air pressure regulator that is installed between the outlet air valve and the air tank of the power plant of the Canadian patent no 2328580, at the height where the value of the hydrostatic pressure of the column of water is equal to the pressure needed to open the said pressure regulator, in order to produce the right compressed air needed for the good functioning of the said power plant, while eliminating the dead volume inside the Line-Cylinder, where the air can be compressed and not pushed out of the compressor.

9—A control circuit to control the operation of the main valve, in order to ensure o good functioning of said hydraulic compressor by allowing atmospheric air to enter the line-cylinder, and compressed air to exit said line-cylinder at the right time.

The length of the line-cylinder can have variable dimensions requiring always an ascending slope in order to permit a full exhaust of all the compressed air of the same stroke.

The water-intake line that brings the water to the compressor, and the Line-Cylinder where the air is compressed can be buried in the ground without affecting the functioning of the said hydraulic compressor, while leaving the soil for the agriculture or for other uses.

The compressed air produced by this type of hydraulic compressors will be used to run power plants of the sort of the Canadian patent no 2328580, with no need to build new dams that flood big areas, however we can still use the dammed water of the existing dams to run the hydraulic compressor of the present invention.

The Other Aspect of this Invention is:

The Lines-Cylinders of this hydraulic compressor of the present invention can be replaced by water reservoirs that can contain bigger flow of water in order to compress a bigger volume of air at a higher discharge pressure, because of the big bases and the lower heights of the said reservoirs that give a bigger hydrostatic pressure which is the consequence of the difference in height between the water intake at the highest level of the water-way, and the higher level the water can rich inside the reservoirs.

Depending on site specifications and the output required, various components, configurations and dimensions for the embodiment may be combined to achieve the desired results. For a better understanding of this invention and to facilitate its examination, it is represented in the following 20 Figures.

### BRIEF DESCRIPTION OF THE DRAWINGS

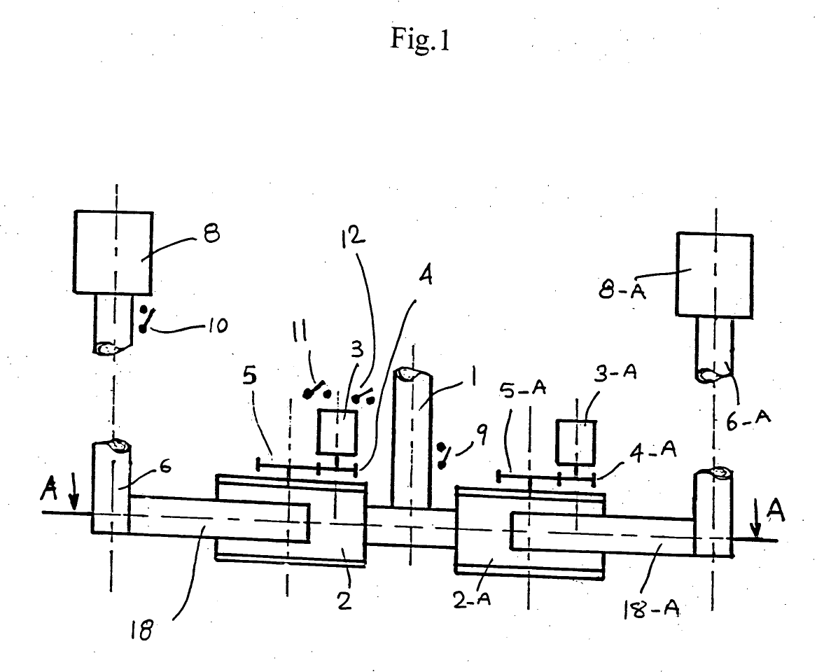

1—FIG. 1 is a front view of the hydraulic compressor.

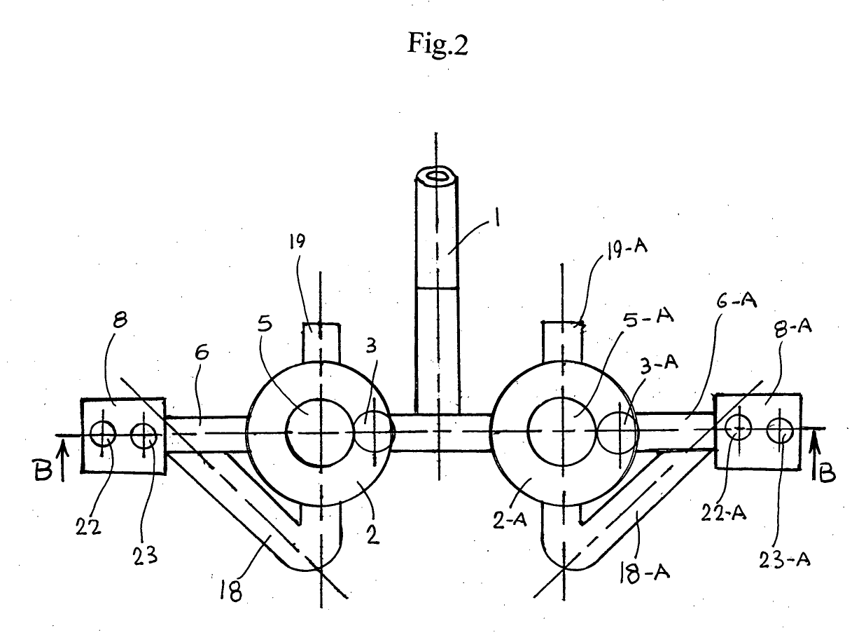

2—FIG. 2 is a top view of FIG. 1.

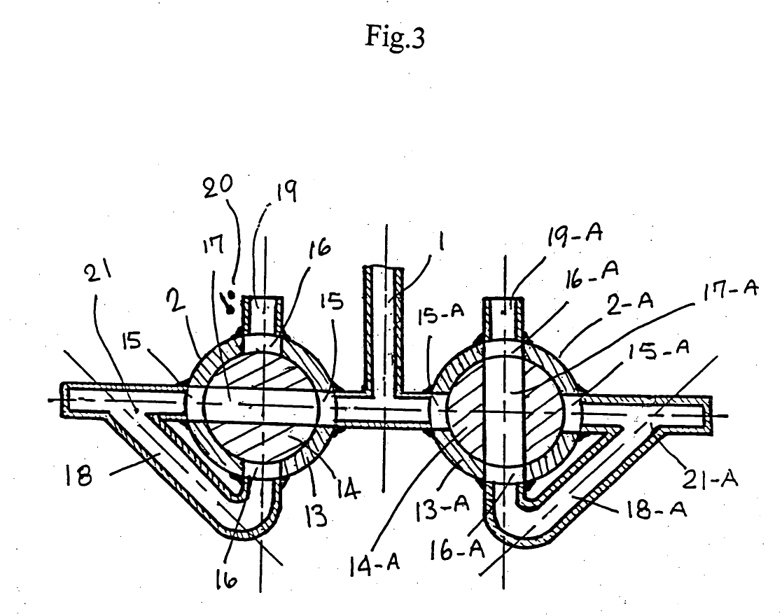

3—FIG. 3 is a top cross-sectional view along line A-A of FIG. 1.

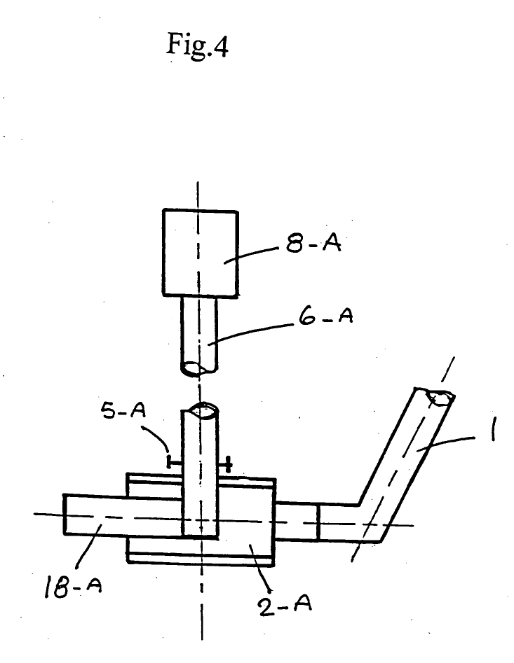

4—FIG. 4 is a right side view of FIG. 1.

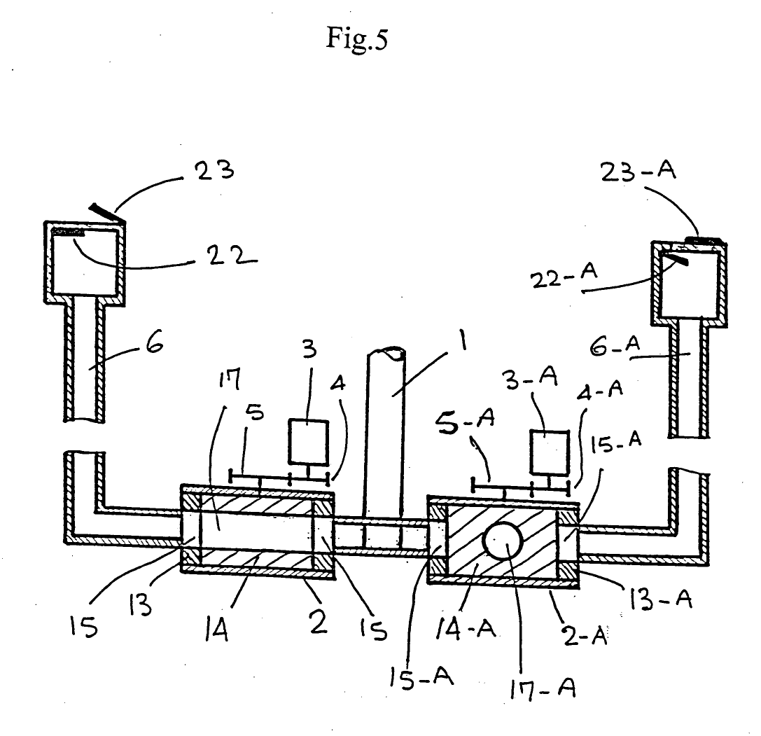

5—FIG. 5 is a cross-sectional view along line B-B of FIG. 2.

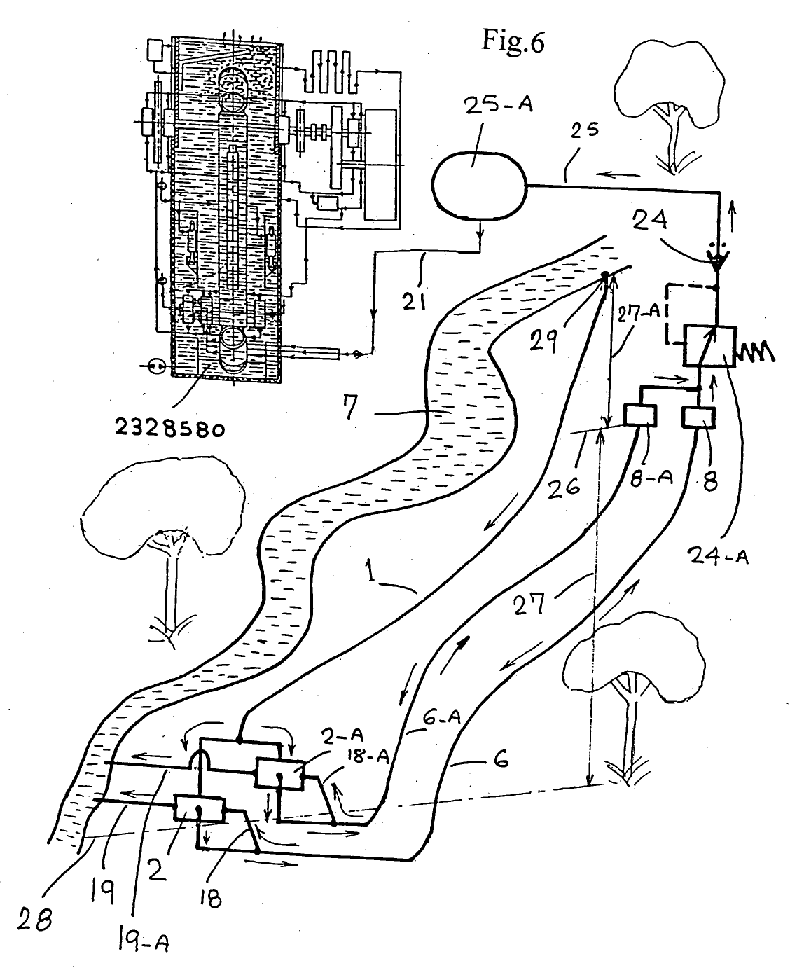

6—FIG. 6 is a schematic representation of the installation of a hydraulic compressor on a water-way, coupled on a power plant of the Canadian patents no 2328580.

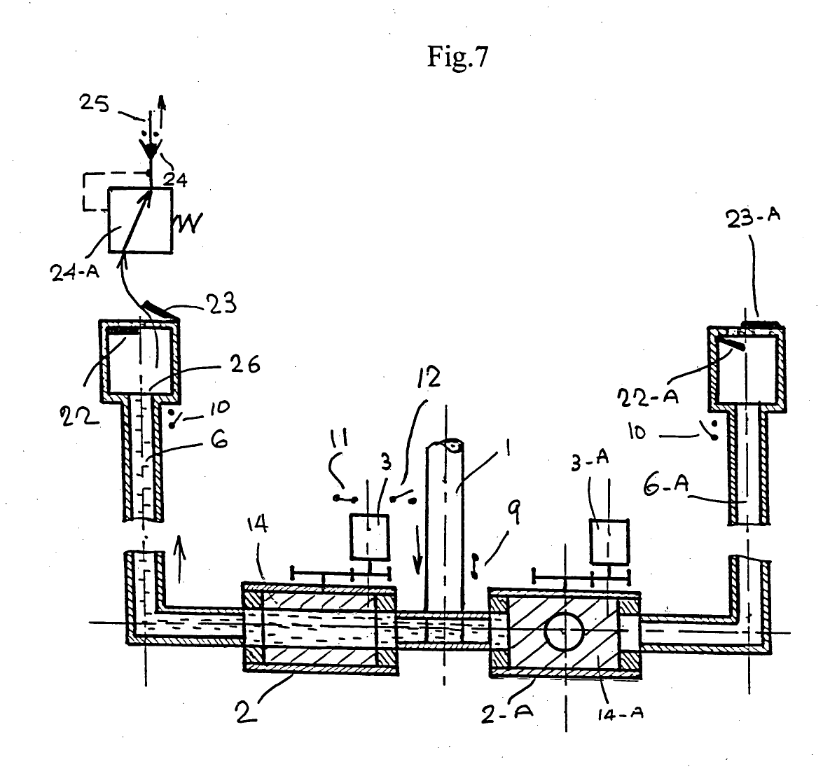

7—FIG. 7 is a cross sectional view along line B-B of FIG. 2, showing the end of the compression in Line-Cylinder 6, and the end of the water discharge or the end of the air-inlet in Line-Cylinder 6-A.

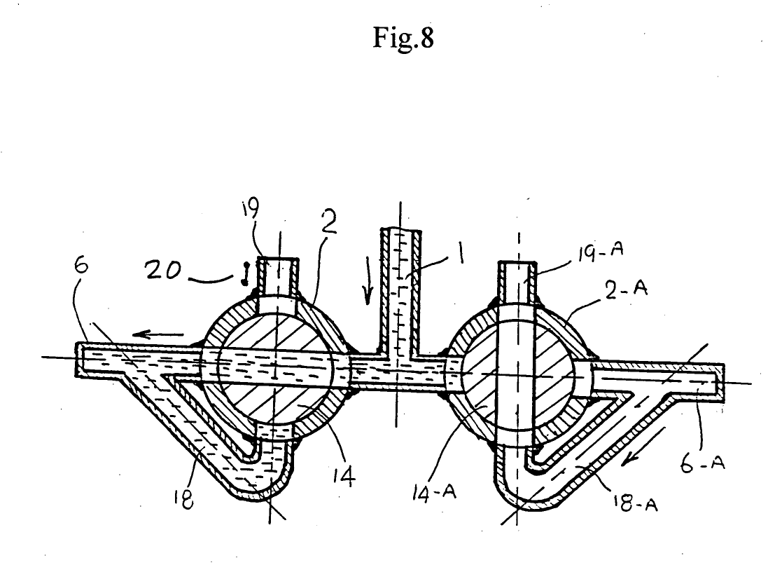

8—FIG. 8 is a cross sectional view along line A-A of FIG. 1, showing the positions of the mobile parts of the main valves of the hydraulic compressor that correspond with FIG. 7.

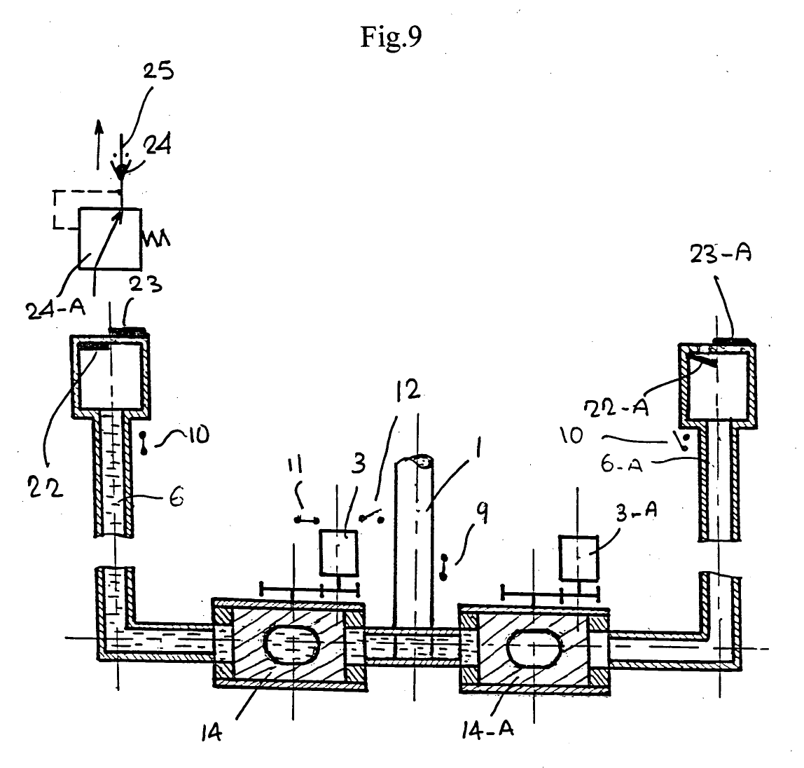

9—FIG. 9 is a cross-sectional view along line B-B of FIG. 2. Showing the beginning of the water discharge cycle from Line-Cylinder 6, and the beginning of the compression cycle in Line-Cylinder 6-A.

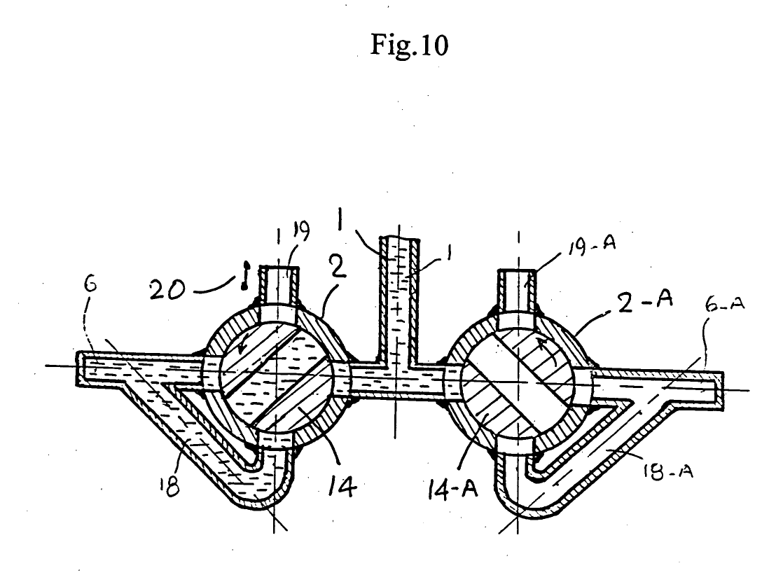

10—FIG. 10 is a cross sectional view along line A-A of FIG. 1, Showing the positions of the mobile parts of the main valves of the hydraulic compressor that correspond with FIG. 9.

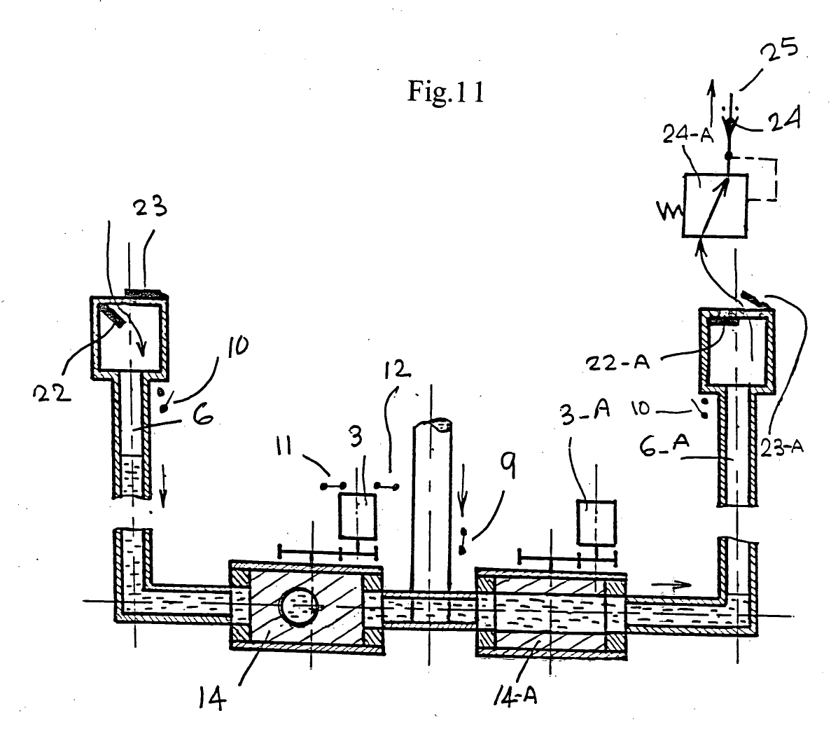

11—FIG. 11 is a cross sectional view along line B-B of FIG. 2, showing the water exiting-Line Cylinder 6, during the air inlet in the same line-cylinder 6, and the water entering Line-Cylinder 6-A while compressing the air imprisoned in the same Line-Cylinder 6-A.

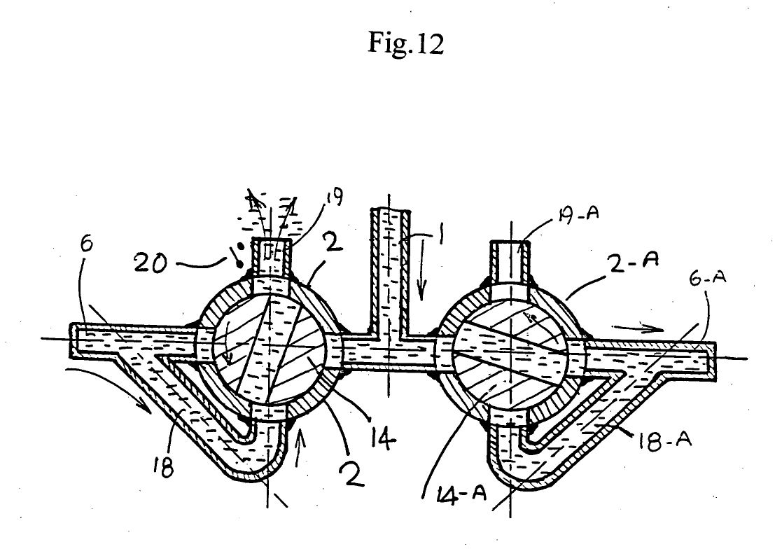

12—FIG. 12 is a cross sectional view along line A-A of FIG. 1, showing the positions of the mobile parts of the main valves of the hydraulic compressor that correspond with FIG. 11.

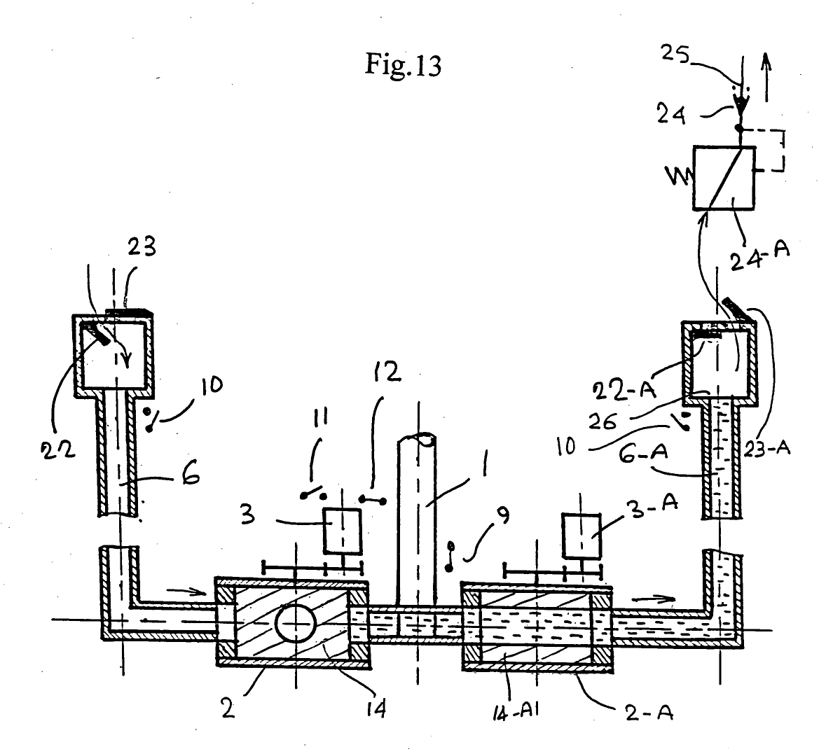

13—FIG. 13 is a cross sectional view along line B-B of FIG. 2. Showing the end of the water discharge cycle from Line-Cylinder 6 or the end of the air-inlet in the same Line-Cylinder 6, and the end of the compression cycle in Line-Cylinder 6-A.

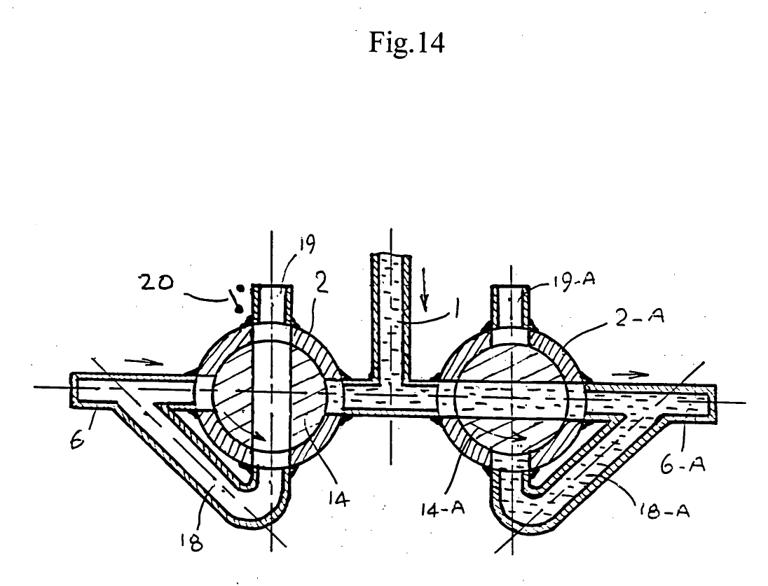

14—FIG. 14 is a cross sectional view along line A-A of FIG. 1, showing the positions of the mobile parts of the main valves of the hydraulic compressor that correspond with FIG. 13.

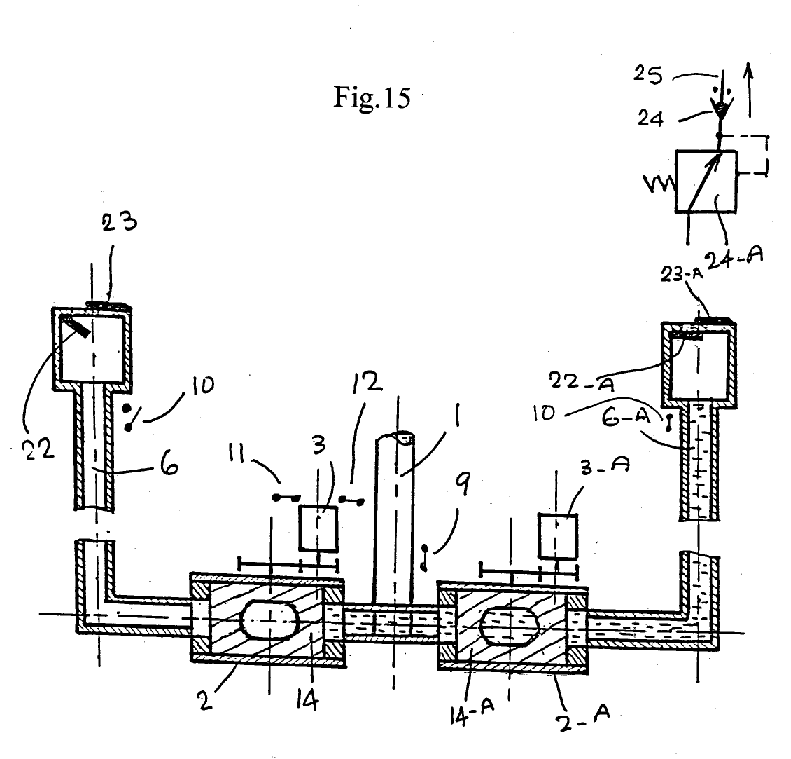

15—FIG. 15 is a cross-sectional view along line B-B of FIG. 2. Showing the beginning of the water discharge cycle from Line-Cylinder 6-A, and the beginning of the compression cycle in Line-Cylinder 6.

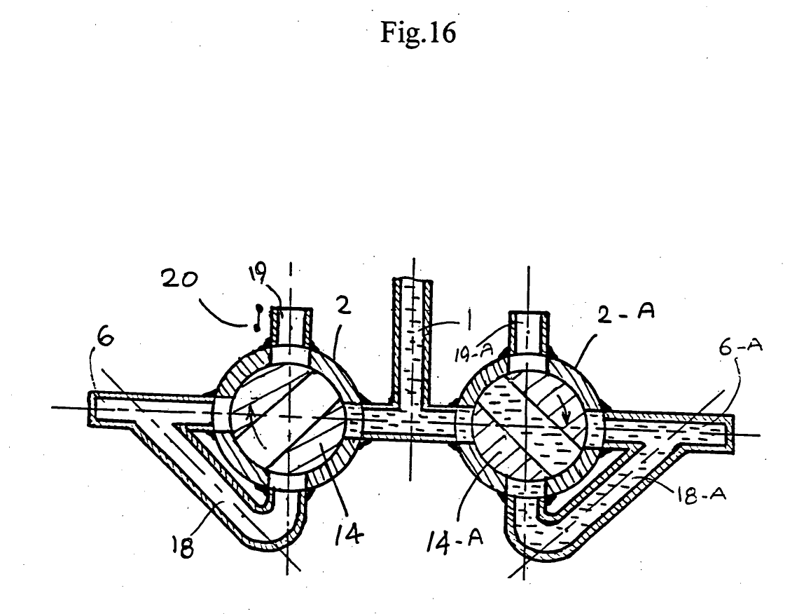

16—FIG. 16 is a cross sectional view along line A-A of FIG. 1, showing the positions of the mobile parts of the main valves of the hydraulic compressor that correspond with FIG. 15.

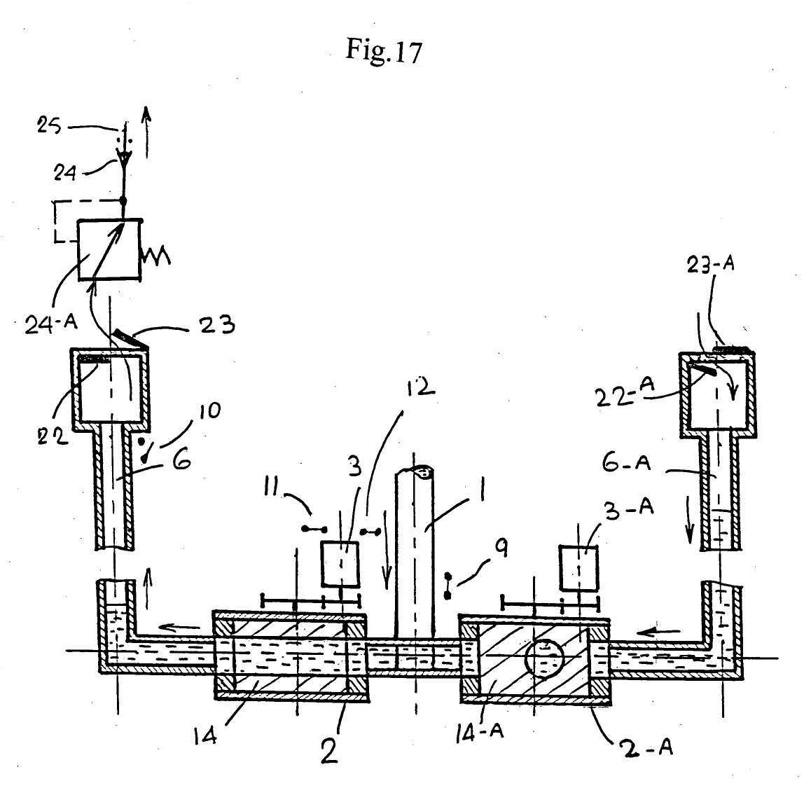

17—FIG. 17 is a cross-sectional view along line B-B of FIG. 2, showing the beginning of the water discharge from Line-Cylinder 6-A, and the beginning of the compression in Line-Cylinder 6.

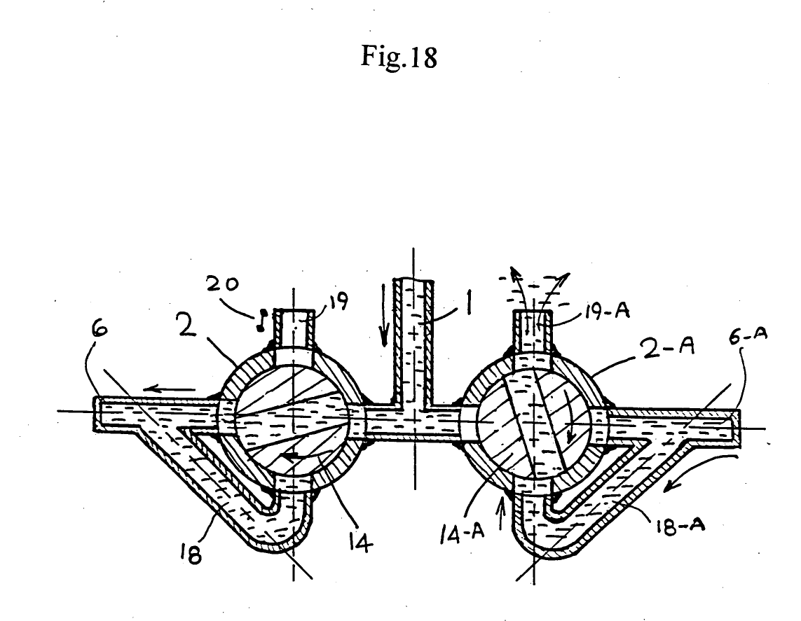

18—FIG. 18 is a cross-sectional view along line A-A of FIG. 1, showing the positions Of the mobile parts of the main valves of the hydraulic compressor that correspond with FIG. 17.

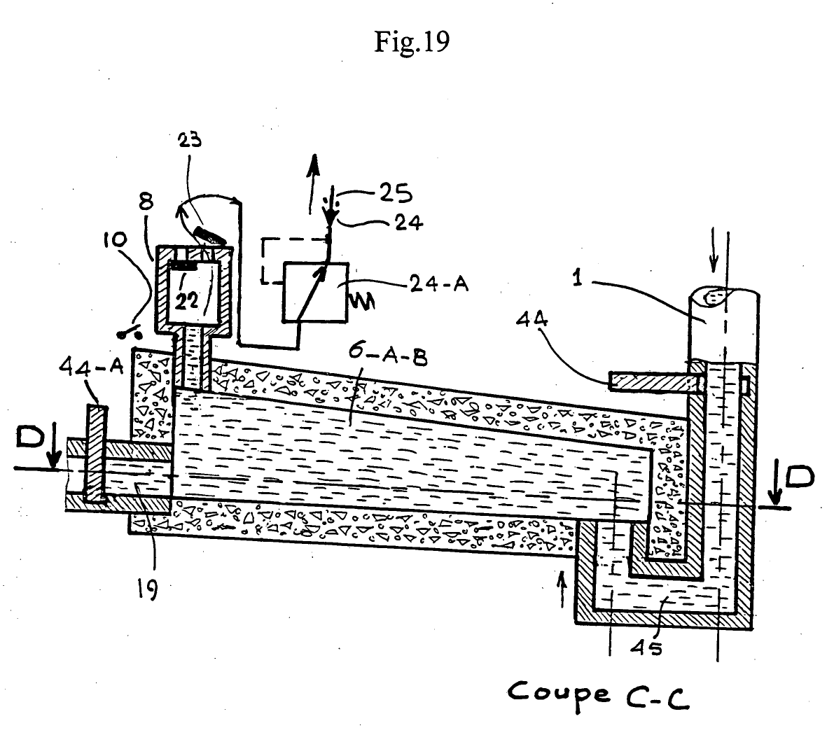

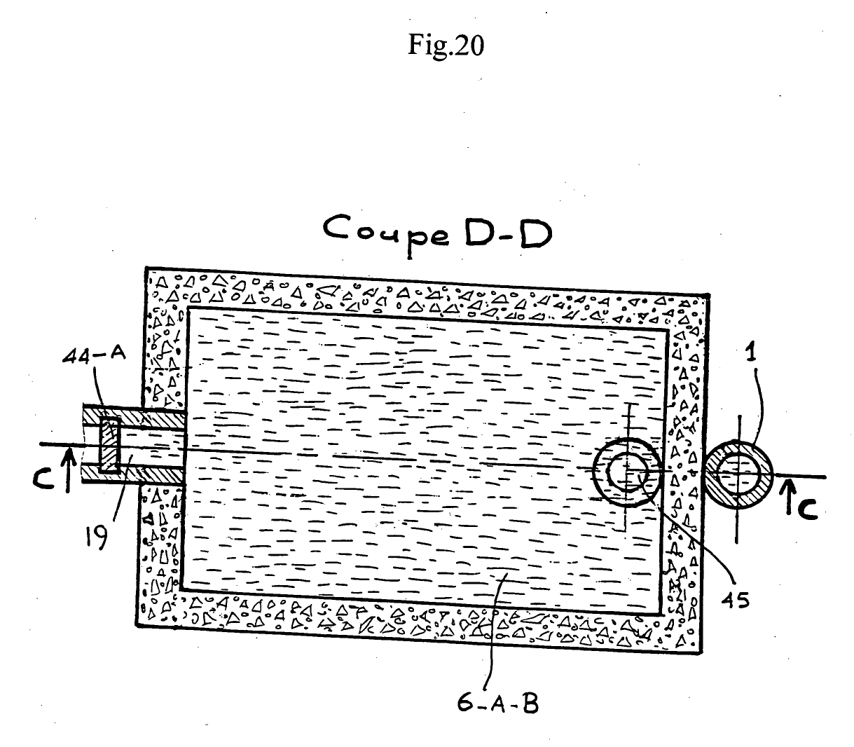

19—FIG. 19 is a schematic cross-sectional view along line C-C of FIG. 20 of a water reservoir that replaces the Line-Cylinder of the hydraulic compressor.

20—FIG. 20 is a schematic cross-sectional view along line D-D of FIG. 19.

### DETAILED DESCRIPTION OF THE INVENTION

When considered with the description herein, the characteristics of the invention are apparent from the accompanying drawings, which exemplify an embodiment of the invention for purposes of illustration only, and in which—

FIG. 1 is a front view of a hydraulic compressor having two Lines-Cylinders 6 and 6-A including the water line 1 that brings water to the compressor from the highest point 29 FIG. 5 of the water-way 7 to the lowest point 28 where the main valves 2 and 2-A that control the water inlet and the water outlet are installed, the electric motors 3 and 3-A that operate the mobile parts 14 and 14-A of the main valves 2 and 2-A through the pinions 4 and 4-A and the gears 5 and 5-A. The Lines-Cylinders 6 and 6-A where air is admitted in order to be compressed by the rising water. The lines 18 and 18-A that transit the outlet water from the Lines-Cylinders 6 and 6-A to the water-way 7 through the main valves 2 and 2-A. the ends 8 and 8-A of the Lines-Cylinders 6 and 6-A where the inlet and outlet valves are installed. The contactors 9 that works with the presence of water in line 1, the second contactor 10 that works with the highest level the water can rich inside the Line-Cylinder 6 at the end of the compression stroke, the third contactor 11 and the fourth contactor 12 that are functioned by the motor 3 in order to control the circuit breakers of the motors 3 and 3-A.

FIG. 2 is a top view of FIG. 1 including the water line 1, the Line-Cylinders 6 and 6-A, the ends 8 and 8-A of the Lines-Cylinders 6 and 6-A where the inlet and outlet valves 22, 22-A and 23 and 23-A are installed, the electric motors 3 and 3-A, that operate the mobile parts 14 and 14-A of the main valves 2 and 2-A through the pinions 4 and 4-A and the gears 5 and 5-A. The lines 18 and 18-A that transit the outlet water from the Lines-Cylinders 6 and 6-A to the water-way 7 through the main valves 2 and 2-A and the discharge lines 19 and 19-A

FIG. 3 is a cross-sectional view along line A-A of FIG. 1 including the line 1, the main valves 2 and 2-A, the fixed parts 13 and 13-A with the mobile parts 14 and 14-A of the main valves 2 and 2-A, the borings 15 and 15-A that are machined radially in the stationary parts 13 and 13-A of the main valves 2 and 2-A and used for the water inlet into the Lines-Cylinders 6 and 6-A. The way the water takes to exit the compressor including the radial borings 16 and 16-A of the fixed parts 13 and 13-A and the radial borings 17 and 17-A of the mobile parts 14 and 14-A of the main valves 2 and 2-A, the gates 21 and 21-A that connect the lower level of the Lines-Cylinders 6 and 6-A to the lines 18 and 18-A in witch the water transits backward to the water-way 7 through the valves 2 and 2-A and the lines 19 and 19-A.

FIG. 4 is a right side view of FIG. 1 including the line 1, the Line-Cylinder 6-A, the line 18-A, the motor 3-A, the pinion 4-A, the gear 5-A, and the end 8-A of the Line-Cylinder 6-A.

FIG. 5 is a front cross-sectional view along line B-B of FIG. 2 including the line 1, the main valves 2 and 2-A, the stationary parts 13 and 13-A with their radial borings 15 and 15-A, the mobile parts 14 and 14-A with their radial borings 17 and 17-A, the Lines-Cylinders 6 and 6-A, the air inlet valves 22 and 22-A, the air outlet valves 23 and 23-A, the motors 3 and 3-A, the pinions 4 and 4-A, and the gears 5 and 5-A.

FIG. 6 is a schematic representation of the installation of a compressor on a water-way, coupled on a power plant of the Canadian patent no 2328580 including the water-way 7, the line 1, the Lines-Cylinders 6 and 6-A. The lines 18, 18-A, 19 and 19-A that transits the water backward from the Lines-Cylinders 6 and 6-A to the water-way 7 through the main valves 2 and 2-A, the ends 8 and 8-A of the Lines-Cylinder 6 and 6-A, the compressed air pressure regulator 24-A, the check valve 24, the air line 25 that connects the compressor to the air tank 25-A, the air tank 25-A. The highest permitted level 26 where the water can rise inside the Lines-Cylinders 6 and 6-A during the compression stroke and where the second electrical contactor 10 is located. The height 27-A of the column of water that determines the pressure of the compressed air, it is located between the water inlet 29 of the compressor and the highest permitted level 26 that the water can rich at the end of every compression stroke inside the Line-Cylinder. The water intake at the highest level 29, and the water discharge at the lowest level 28 where the main valves 2 and 2-A are installed.

FIGS. 7 to 18 represent front cross-sectional views along line B-B of FIG. 2, and top cross-sectional views along line A-A of FIG. 1. These views show all the stapes of the inlet and the outlet of the water and the air of the compressor in one period, including all the elements that are in FIGS. 3 and 5 in addition to the pressure regulator 24-A, the check valve 24 and the air line 25 that transits the compressed air from the compressor to the air tank 25-A of the power plant of the Canadian patent no 2328580.

FIG. 19 is a cross-sectional view along line C-C of FIG. 14 of the water reservoir 6-A-B that replaces the Line-Cylinder of the hydraulic compressor the subject of the present invention including the water line 1, the discharge gate 19, the end 8, the air inlet valve 22, the air outlet valve 23, the pressure regulator 24-A, the water inlet gate 44 that controls the water admission into the reservoir 6-A-B, the tunnel 45 in which the water access to the reservoir 6-A-B coming from the water line 1. The water gate 44-A that controls the water discharge from the reservoir 6-A-B to the water-way 7 and the second contactor 10

FIG. 20 is a cross-sectional view along line D-D of FIG. 13 including the reservoir 6-A-B, the water line 1, the water gates 45 and 44-A, and the water discharge line 19.

It should be understood, of course, that this compressor can be built from various materials and in different dimensions according to the quantity of compressed air required. The drawings do not show every step in the construction of the present invention, but they set out the overall result clearly.

According to the example of the present invention, the hydraulic compressor has two Lines-Cylinders, and before starting it, all of its components must be in place in order to produce compressed air.

1—First the location of the hydraulic compressor is chosen in order to determine the distance between the highest level for the water intake of the said compressor and the lowest level for the water discharge, that helps to locate the pressure regulator and to determine the discharge compressed air pressure, in order to build the appropriate power plant of the Canadian patent no 2328580 that can function with the actual compressed air of the said hydraulic compressor.

2—The water line 1 will be in place in order to transit the water from the water intake at level 29, to level 28 where the main valves are installed.

3—The main valve 2 will be in place to connect from one side the water line 1, and from the other side the Line-Cylinder 6. In addition the water line 18 will be in place to transit the discharged water after every compression stroke through the main valve 2 to the water-way 7. Equally the main valve 2-A will be in place to connect from one side the water line 1, and from the other side the Line-Cylinder 6-A. In addition the water line 18-A will be in place to transit the discharged water after every compression stroke through the main valve 2-A to the water-Way 7.

4—The Lines-Cylinders 6 and 6-A will be in place in an ascending position that permits to the water to compress and discharge toward the air tank 25-A all of the admitted air inside the compressor.

5—the air tank 25-A will be in place to receive the compressed air from the hydraulic compressor the subject of the present invention through the air outlet valve 23, the pressure regulator 24-A, the check valve 24 and the air line 25.

6—the power plant of the Canadian patent 2328580 will be in place to receive the compressed air through the air line 21.

Operation of the Invention.

The said hydraulic compressor can have any number of line-cylinders that work according to the same method. The following is the functioning of line-cylinder 6 as an example:

1—Once all the components are in place, the hydraulic compressor is ready to run.

2—A first role of the radial boring 17 of the mobile part 14 of the main valve 2 is fulfilled when the said radial boring 17 gets in line with the two borings 15 of the stationary part 13 of the main valve 2, to let water coming from the source by line 1 to enter the line-cylinder 6 of the compressor, in order to compress the imprisoned air, while the communication between the Line-Cylinder 6 at its lower level and the waterway 7 through the two borings 16, is blocked by the same mobile part 14 of the main valve 2.

3—Considering that the boring 17 of the mobile part 14 is communicating between the borings 15 of the stationary part 13 of the main valve 2, we open the gate that lets the water in the first water line 1 and then to the Line-Cylinder 6 through the main valve 2 to compress the existing air.

4—The water starts rising in the Line-Cylinder 6 while compressing the imprisoned air and forcing it to go to the air tank 25-A through the outlet valve 23, the pressure regulator 24-A, the check valve 24 and the air line 25 that connects the compressor to the air tank 25-A.

5—When the water arrives at the highest permitted level 26 inside the Line-Cylinder 6 where the pressure regulator 24-A is placed, it sets on the electrical contactor 10 that connects the electrical power to a first circuit breaker in order to start the motor 3 that starts turning the mobile part 14 of the above-mentioned main valve 2 in one direction.

6—When the motor 3 starts turning the mobile part 14 of the main valve 2 in one direction, in order to close the water inlet passage between the borings 15 that stops by this move the air compression, and opens partially little time later the water outlet passage, between the borings 16 that exits the water from the line-cylinder 6 toward the waterway 7. When the motor 3 of the main valve 2 arrives at the end of its run in the actual direction, and after the water discharge passage is completely open, the contactor 11 will be set off in order to cut the electrical power from a circuit breaker that stops the motor in order to give time to complete the water discharge toward the waterway 7.

7—A second role of the radial boring 17 of the mobile part 14 was fulfilled when this radial boring 17 got in line with the borings 16 of the same stationary part 13 that has the first boring communicating with the Line-Cylinder 6 at its lower level, and the second boring communicating with the waterway 7, in order to facilitate the water discharge after the exhaust of the compressed air of every cycle.

8—The depression created during the water discharge inside the Line-Cylinder 6, closes the compressed air outlet valve 23, and opens the air inlet valve 22 in order to replace the water by atmospheric air.

9—When the water stops flowing out of the compressor to the waterway 7, the contactor 20 connects the electrical power to a second circuit breaker that connects the electrical current to the motor 3 of the main valve 2 that gives the following results:
A—In the beginning of the same run that was travelled in the other direction, the blockage of the outlet passage of the water is ensured when the boring 17 of the mobile part 14 of the main valve 2 cuts off the communication between the lower level of the Line-Cylinder 6 and the exterior of the compressor. While continuing to turn the mobile part 14, the boring 17 realises the communication between the source of the water and the inside of the compressor namely the interior of the Line-cylinder 6 through line 1, that starts a new compression stroke.
B—At the end of the run of the said mobile part 14 of the main valve 2 in the actual direction, the contactor 12 is set off in order to stop the motor of the main valve. By now the compressor is ready for the next cycle.
C—As the contactor 10 is off, the water keeps flowing and rising in the compressor while compressing and pushing out of the said compressor the imprisoned air, until it reaches again the highest permitted level 26 inside the Line-Cylinder 6, where it sets on the contactor 10 in order to turn on the motor of the main valve 2, that starts another working cycle for the hydraulic compressor, and so on.

According to the example of the present invention, the compressor has two Lines-Cylinders 6 and 6-A. Hence the second main valve 2-A of the second Line-Cylinder 6-A will be activated by a second electrical motor 3-A that is supplied in a parallel way with the first motor 3 of the first Line-Cylinder 6, by the same electrical circuit, but the cycles will be inversed, that means:

When there is water admission in the first Line-Cylinder 6, it will be water discharge from the second Line-Cylinder 6-A to the water-way, that means air compression in the Line-Cylinder 6 and air inlet in the Line-Cylinder 6-, and vice versa. Only one electrical circuit is needed to operate the electrical motors of the compressor's main valves of the same compressor, but the contactors and the circuit breakers of only one Line-Cylinder are used in order to facilitate the operation of the said hydraulic compressor the subject of the present invention.

In summary, the main advantage of this invention is to produce compressed air in an effective way through the use of the renewable energy of any waterway, in order to supply especially any location in remote areas where the power is in need. At a condition to have water flowing with a difference in heights between the water intake and the water discharge of the said hydraulic compressor the subject of the present invention. We knew that in raining time many places have flowing waterways!

It should be understood, of course, that the foregoing disclosure relates to only a preferred embodiment of the invention, and that it is intended to cover all changes, and modifications of the example of the invention herein chosen, for the purposes of the disclosure, which do not constitute departures from the spirit and scope of the invention.

The embodiments of the invention in which an exclusive property or privilege is claimed are defined as folows:

1- Hydraulic compressor for compressing air by utilising the potential energy of water, comprising:
a water line having an inlet and an outlet, the inlet located at an upstream of a water source, the outlet located at a downstream of said water source;
a line-cylinder having an inlet and an outlet, located downstream of the water source close to the outlet of said water line, the outlet of said line cylinder is located at a higher location than the inlet of said line cylinder;
a main rotary valve means connecting the outlet of the water line and the inlet of the line cylinder such that during compression cycle the valve means allow water to flow from the water line to the line cylinder so that the water in the water line flows into the line cylinder to compress the air inside the line cylinder; and such that in an exhaust cycle the valve means allow water in the line cylinder to flow back through the valve and back into the waterway while at the same time closing the supply of water from the water line;
air inlet and outlet valve means located in the upper end of the line cylinder such that during the compression cycle, compressed air is allowed to flow out of the line cylinder and into an air tank at a predetermined discharge pressure; and such that during the water exhaust cycle, atmospheric air is allowed to enter the line cylinder at the end of the compression cycle to replace the discharged water.

2- Hydraulic Compressor as claimed in claim 1 and characterised by said main valve means, includes:
a stationary cylindrical part that has four radial bores along the periphery of the stationary part and spaced 90 degrees between each other;
a mobile part rotatable within the stationary part and has a radial boring that connects any two opposite borings in said stationary part while blocking the other two borings as the mobile part rotates;
the outlet of the water line and the inlet of the line cylinder being connected to two opposite bores spaced 180 degrees apart, one of the other two bores is connected to a discharge pipe that discharges water from the line cylinder at the end of the compression cycle, and the other bore is connected to a bypass pipe; the bypass pipe is connected to the line cylinder at its lower level;
control means for operating the valve means.

3- Hydraulic Compressor as claimed in claim 1 and characterised by:
The installation of the water line that replaces the cylinder in a conventional compressor, in an ascending position in order to compress and expel to the air tank all of the air that is admitted in the compressor during every cycle

4- Hydraulic Compressor as claimed in claim 1 wherein the cylinder is a pipe.

5- Hydraulic Compressor as claimed in claim 1 wherein the line cylinder is a reservoir.

6- Hydraulic Compressor as claimed in claim 5 and characterised by:
tunnels that replace the borings in the fixed and the mobile parts of the main valve of the said hydraulic compressor,
water gates to control the water inlet and the water outlet of big quantities of water of the said hydraulic compressor when it is needed to compress and deliver big quantities of air.
